(19) United States
(12) Patent Application Publication
(10) Pub. No.: US 2003/0086231 A1
(43) Pub. Date: May 8, 2003

(54) Power conversion apparatus

(75) Inventors: Takeaki Asaeda, Tokyo (JP); Hiroshi Masunaga, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/260,403

(22) Filed: Oct. 1, 2002

(30) Foreign Application Priority Data
Nov. 2, 2001 (JP) 2001-337330

(51) Int. Cl. H02H 9/08

(52) U.S. Cl. 361/93.9

(57) ABSTRACT

In a power conversion apparatus, a first switch is connected in series with a dc capacitor between P and N terminals of a dc circuit. The first switch is formed of a switched valve device and a diode connected in reverse parallel with each other. The switched valve device of the first switch and switched valve devices used in individual arms of a second power converter are voltage-driven switched valve devices. An on-gate voltage of the switched valve device of the first switch is made lower than an on-gate voltage of the switched valve devices of the second power converter.

### BACKGROUND OF THE INVENTION

1. Field of the Invention

The present invention relates to an arrangement for protecting switched valve devices used in a power conversion apparatus in the event of a breakdown, or a sudden direct current discharge (hereinafter referred to as the dc short circuit), in the power conversion apparatus.

2. Description of the Background Art

An example of a conventional power conversion apparatus is introduced in the proceedings of the 1983 International Power Electronics Conference held in Tokyo, Japan (IPEC-Tokyo '83) under the title of “Protection of Voltage Source Inverters” (pages 882-893). An approach taken in this conventional power conversion apparatus is to insert a reactor fitted with a freewheeling diode in a dc circuit as shown in FIG. 6 of the paper for suppressing the rising edge of a short-circuit current when it occurs due to an anomaly in a gate circuit or in a switched valve device of the apparatus. This conventional arrangement, however, poses a problem that it leads to an increase in component size as well as a cost increase.

Another problem experienced in a power conversion apparatus, in which a dc capacitor is connected to a converter or an inverter for suppressing ripples, is that if a dc short circuit occurs in a switched valve device of any phase of the apparatus due to malfunction or partial breakdown, discharge current from the dc capacitor would flow through devices in the short-circuited phase, resulting in a destruction of all the devices in that phase.

### SUMMARY OF THE INVENTION

The invention has been made with a view to solving the aforementioned problems of the prior art. Accordingly, it is an object of the invention to provide a power conversion apparatus which can reliably protect switched valve devices from short-circuit currents discharged from dc capacitors of the power conversion apparatus in the event of a dc short circuit.

According to a principal aspect of the invention, a power conversion apparatus includes a dc circuit formed of a series-connected unit including a dc capacitor and a first switching unit employing a first switched valve device, and a dc-ac conversion unit which is formed of a plurality of arms individually employing second switched valve devices and, connected to the dc circuit, converts dc power into ac power, wherein the first switched valve device suppresses short-circuit current which flows through any healthy one of the arms when a dc short circuit has occurred due to a failure of any one of the arms. In this power conversion apparatus, voltage-driven switched valve devices are used as the first and second switched valve devices and, on the grounds that the duty cycle of the first switched valve device is lower than that of the second switched valve devices during operation, on-gate voltage of the first switched valve device is made lower than that of the second switched valve devices, thereby enhancing an effect of suppressing the short-circuit current of the first switched valve device.

This construction serves to effectively suppress the short-circuit current and protect any healthy devices in a reliable fashion.

According to another principal aspect of the invention, a power conversion apparatus includes a dc circuit formed of a series-connected unit including a dc capacitor and a first switching unit employing a first switched valve device, and a dc-ac conversion unit which is formed of a plurality of arms individually employing second switched valve devices and, connected to the dc circuit, converts dc power into ac power, wherein the first switched valve device suppresses short-circuit current which flows through any healthy one of the arms when a dc short circuit has occurred due to a failure of any one of the arms. In this power conversion apparatus, voltage-driven switched valve devices having approximately the same current capacity are used as the first and second switched valve devices and, on the grounds that the duty cycle of the first switched valve device is lower than that of the second switched valve devices during operation, the number of constituent devices arranged in parallel to constitute the first switched valve device is made smaller than the number of constituent devices arranged in parallel to constitute each of the second switched valve devices, thereby enhancing an effect of suppressing the short-circuit current of the first switched valve device.

This construction also serves to effectively suppress the short-circuit current and protect any healthy devices in a reliable fashion. It is to be noted that the expression “constituent devices” as used in the present Specification and the appended claims refers to “sub-devices” which are arranged in parallel with one another and together constitute a switched valve device.

These and other objects, features and advantages of the invention will become more apparent upon reading the following detailed description in conjunction with the accompanying drawings.

### BRIEF DESCRIPTION OF THE DRAWINGS

FIG. 1 is a circuit diagram showing the configuration of a primary circuit of a power conversion apparatus according to a first embodiment of the invention;

FIG. 2 is a characteristics diagram of switched valve devices used in the first embodiment of the invention;

FIG. 3 is a characteristics diagram of switched valve devices used in a second embodiment of the invention;

FIG. 4 is a circuit diagram showing the configuration of a primary circuit and a control circuit of a power conversion apparatus according to a third embodiment of the invention;

FIG. 5 is a circuit diagram showing the configuration of a primary circuit and a control circuit of a power conversion apparatus according to a fourth embodiment of the invention;

FIG. 6 is a circuit diagram showing the configuration of a primary circuit and a control circuit of a power conversion apparatus according to a fifth embodiment of the invention;

FIGS. 7A and 7B are diagrams showing operation waveforms of the primary circuit of a power conversion apparatus according to the fifth embodiment of the invention;

FIG. 8 is a circuit diagram showing the configuration of a primary circuit of a power conversion apparatus according to a sixth embodiment of the invention;

FIG. 9 is a circuit diagram showing the configuration of a primary circuit and a control circuit of a power conversion apparatus according to a seventh embodiment of the invention;

FIG. 10 is a circuit diagram showing the configuration of a primary circuit and a control circuit of a power conversion apparatus according to an eighth embodiment of the invention;

FIG. 11 is a diagram showing operation waveforms of the primary circuit of the power conversion apparatus according to the eighth embodiment of the invention;

FIG. 12 is a circuit diagram showing the configuration of a primary circuit of a power conversion apparatus according to a ninth embodiment of the invention;

FIG. 13 is a circuit diagram showing the configuration of a primary circuit of a power conversion apparatus according to a tenth embodiment of the invention;

FIG. 14 is a circuit diagram showing the configuration of a primary circuit of a power conversion apparatus according to an eleventh embodiment of the invention;

FIG. 15 is a circuit diagram showing the configuration of a primary circuit and a control circuit of a power conversion apparatus according to a twelfth embodiment of the invention;

FIG. 16 is a circuit diagram showing the configuration of a primary circuit and a control circuit of a power conversion apparatus according to a thirteenth embodiment of the invention;

FIG. 17 is a circuit diagram showing the configuration of a primary circuit of a power conversion apparatus according to a fourteenth embodiment of the invention; and

FIG. 18 is a circuit diagram showing the configuration of a primary circuit of a power conversion apparatus according to a fifteenth embodiment of the invention.

### DESCRIPTION OF THE PREFERRED EMBODIMENTS

### First Embodiment

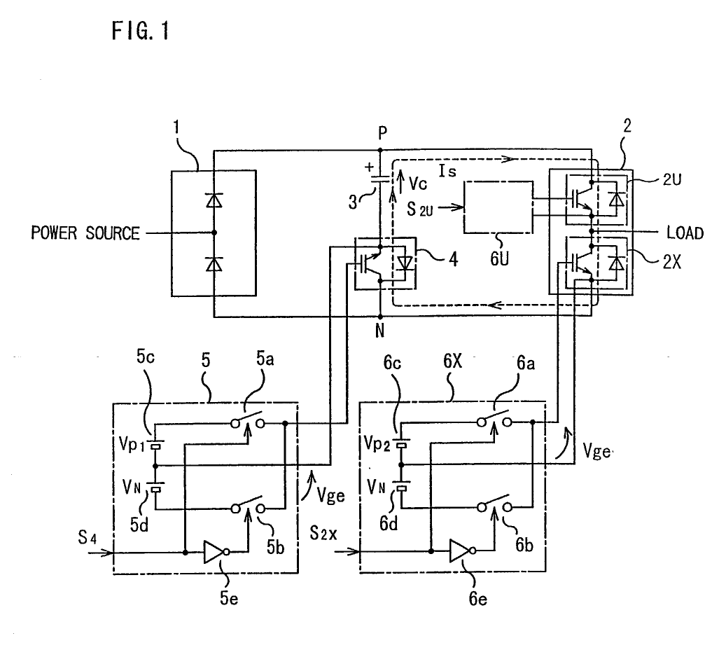

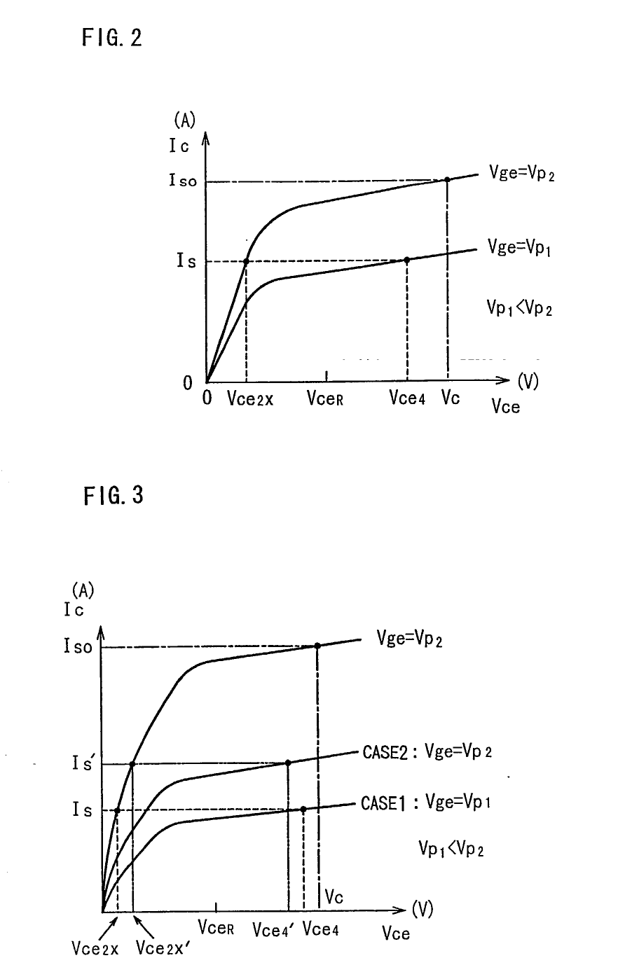

A power conversion apparatus according to a first embodiment of the invention is now described with reference to FIGS. 1 and 2. In FIG. 1 showing a circuit configuration for one phase of the apparatus, designated by the numeral 1 is a first power converter serving as an ac-dc conversion unit for converting ac power into dc power which is connected to P and N terminals of a dc circuit, designated by the numeral 2 is a second power converter (inverter) serving as a dc-ac conversion unit including arms (circuit branches) 2U and 2X for one phase, each arm (2U, 2X) being formed of a voltage-driven switched valve device (second switched valve device) and a diode connected in reverse parallel with each other. Connected to the P and N terminals of the dc circuit, this second power converter 2 converts dc power into ac power which is supplied to a load. Further, designated by the numeral 3 is a dc capacitor, and designated by the numeral 4 is a first switch formed of a voltage-driven switched valve device (first switched valve device) and a diode connected in reverse parallel with each other. The dc capacitor 3 and the first switch 4 are series-connected between the P and N terminals.

Referring again to FIG. 1, designated by the numeral 5 is a gate circuit of the first switch 4, in which designated by the numerals 5a and 5b are on-gate and off-gate switches and designated by the numerals 5c and 5d are on-gate and off-gate power sources for the first switch 4, respectively. Designated by the numerals 6U and 6X are gate circuits for the arms 2U and 2X of the second power converter 2, respectively. Further, designated by the numerals 6a and 6b are on-gate and off-gate switches and designated by the numerals 6c and 6d are on-gate and off-gate power sources for the second power converter 2, respectively.

Now, operation of the power conversion apparatus of this embodiment is described in the following. Insulated-gate bipolar transistors (IGBTs) and metal-oxide-semiconductor field-effect transistors (MOSFETs) are typical examples of voltage-driven switched valve devices. The first switch 4 and the second power converter 2 of FIG. 1 employ IGBTs of the same rated capacity. The IGBT and the diode of the first switch 4 are connected in such a way that the IGBT conducts when the dc capacitor 3 discharges and the diode conducts when the dc capacitor 3 is charged.

The first power converter 1 is a diode rectifier, whereby voltage Vc across the dc capacitor 3 is maintained at a voltage obtained by rectifying an the input ac power. While the second power converter 2 is in operation, the IGBT in the first switch 4 is held in an ON state by a gate signal S4 fed from the gate circuit 5. More specifically, the gate signal S4 is in a high (H) state and, with the on-gate switch 5a in the gate circuit 5 conducting, output voltage Vp1 of the on-gate power source 5c is maintained at the same level as gate voltage Vge of the IGBT in the first switch 4 in this situation. On the other hand, output voltage Vp2 of the on-gate power source 6c for the IGBTs in the arms 2U, 2X of the second power converter 2 has a relationship expressed by the inequality Vp1<Vp2 with the output voltage Vp1 of the on-gate power source 5c as will be described later.

When the two IGBTs in the arms 2U, 2X of the second power converter 2 conduct simultaneously due to malfunction or partial breakdown, for example, a dc short-circuit current Is flows through a path shown by broken lines in FIG. 1. When the IGBT in the second power converter 2U of the second power converter 2 breaks, causing a short circuit, for example, the value of the dc short-circuit current Is flowing through the path is determined by the relationship between the sum of a collector voltage Vce4 of the IGBT in the first switch 4 and a collector voltage Vce2X of the IGBT in the arm 2X of the second power converter 2 and the voltage Vc across the dc capacitor 3. This means that the dc short-circuit current Is is suppressed under conditions in which there is a relationship expressed by Vc=Vce4+Vce2X.

Voltage-driven switched valve devices, of which typical example is the IGBT, are characterized in that their collector current Ic is dependent on gate voltage. Specifically, they have a characteristic that the collector current Ic increases with an increase in on-gate voltage. From the viewpoint of ohmic loss characteristics, the switched valve devices show a tendency that their ohmic loss increases as the on-gate voltage is decreased. It is therefore necessary to increase the on-gate voltage of the IGBTs of the second power converter 2, which are continually turned on and off, to prevent an increase in its turn-on switching loss.

Compared to the switched valve devices of the second power converter 2 which continually turned on and off, the switched valve device of the first switch 4 is kept continuously in the ON state in operation without being turned on and off. In other words, the duty cycle of the switched valve device of the first switch 4 is lower than that of the switched valve devices of the second power converter 2. Focusing on this fact, the inventors of this invention have succeeded in considerably enhancing the effect of suppressing the dc short-circuit current Is which is determined by the aforementioned equation by making on-gate voltage Vp1 of the switched valve device of the first switch 4 lower than on-gate voltage Vp2 of the switched valve devices of the second power converter 2 and thereby increasing the collector voltage Vc appearing on the switched valve device of the first switch 4.

This effect is further explained referring to FIG. 2. Because Vp1<Vp2, there occurs a difference between the collector voltage Vce4 of the IGBT in the first switch 4 and the collector voltage Vce2X of the IGBT in the arm 2X of the second power converter 2 due to the aforementioned gate voltage dependency of the collector current Ic, which is characteristic of the voltage-driven switched valve devices, as shown in FIG. 2. This is because the voltage-driven switched valve devices have a characteristic that the collector current Ic increases with an increase in on-gate voltage as stated above. As a consequence, Vce4 becomes higher than Vce2X (Vce4>Vce2X) and the dc short-circuit current Is determined by the relationship Vc=Vce4+Vce2X is significantly decreased.

A characteristic curve of which one point is shown by alternate long and short dashed lines in FIG. 2 indicates a dc short-circuit current Iso observed when the first switch 4 is not provided. It can be seen from FIG. 2 that, compared to the dc short-circuit current Iso of this case, the dc short-circuit current Is is remarkably decreased thanks to the provision of the first switch 4 which makes the on-gate voltage Vp1 smaller than the on-gate voltage Vp2 (Vp1<Vp2). The result is that the possibility of destruction of a healthy arm (2U or 2X) of the second power converter 2 due to short-circuit current flowing from the dc capacitor 3 caused by a failure of the other arm is considerably decreased.

While FIG. 1 shows the circuit configuration in which an externally commutated converter formed of diode rectifiers is used as the first power converter 1 for the sake of simplicity, the same advantageous effect as described above would be obtained even when a self-commutated converter like the second power converter 2 is used as the first power converter 1.

### Second Embodiment

FIG. 3 is a characteristics diagram showing dc short-circuit currents observed in a second embodiment of the invention. The second embodiment is characterized in that the number of constituent devices arranged in parallel to constitute a switched valve device of a first switch 4 is made smaller than the number of constituent devices arranged in parallel to constitute each switched valve device of a second power converter 2 taking into consideration the fact that the duty cycle of the former is lower than that of the latter in operation, to drastically decrease the dc short-circuit current.

The foregoing discussion of the first embodiment illustrated in FIG. 1 has dealt with a case where the arm devices of the first switch 4 and the second power converter 2 have the same rated capacity. In contrast, shown by broken lines in FIG. 3 is voltage distribution of individual devices for a case where the number of constituent devices arranged in parallel to constitute the switched valve device of the first switch 4 is one and its on-gate voltage is Vp1 (case 1) and the number of constituent devices arranged in parallel in each-arm of the second power converter 2 is two and their on-gate voltage is Vp2, for example, while the devices have the same rated capacity. The dc short-circuit current Is is limited under conditions in which there is a relationship expressed by Vc=Vce4+Vce2X between voltage Vce4 appearing on the device in the first switch 4 and voltage Vce2X appearing on the device in an arm 2X of the second power converter 2 have a relationship expressed by Vc=Vce4+Vce2X. In a case where the first switch 4 is not provided, Vce2X becomes equal to Vc (Vce2X=Vc), causing a dc short-circuit current Iso shown by alternate long and short dashed lines, which is increased to more than twice compared to the case in which the first switch 4 is provided.

The effect of suppressing the dc short-circuit current is also obtained when the number of constituent devices arranged in parallel in the switched valve device of the first switch 4 is one and its on-gate voltage is Vp2 (case 2). In this case, the dc short-circuit current is suppressed to Is′ under conditions in which there is a relationship expressed by Vc=Vce4′+Vce2X′ as shown by alternate long and two short dashed lines in FIG. 3, from which it is understood that the dc short-circuit current can be significantly decreased (approximately one half) in the case 2 compared to a case in which the first switch 4 is not provided.

As can be seen from the foregoing discussion, it is possible to considerably decrease the dc short-circuit current and prevent a secondary failure of the arm devices of the second power converter 2 by using the devices of approximately the same current capacity and making the number of constituent devices arranged in parallel in the switched valve device of the first switch 4 smaller than that in each arm of the second power converter 2.

If the on-gate voltage Vp1 for the device of the first switch 4 is made lower than the on-gate voltage Vp2 for the devices of the second power converter 2 (Vp1<Vp2), the effect of suppressing the dc short-circuit current is further enhanced as shown in the case 1 of FIG. 3.

### Third Embodiment

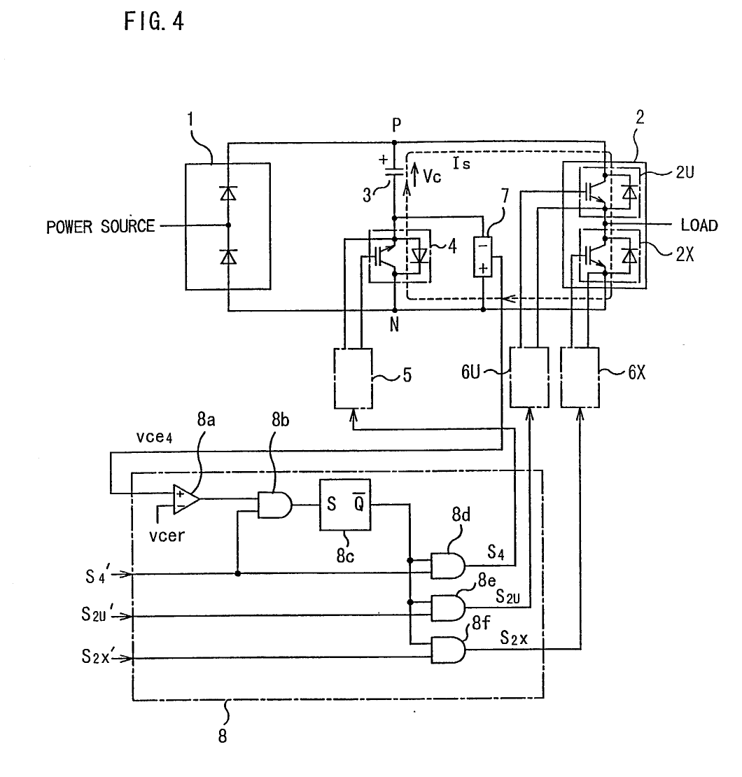

FIG. 4 is a circuit diagram of a power conversion apparatus according to a third embodiment of the invention particularly showing a control method for dc short-circuit protection. Referring to FIG. 4, designated by the numeral 7 is a first voltage detector for detecting collector voltage Vce4 of a first switch 4 and designated by the numeral 8 is a dc short-circuit control circuit for controlling a gate of each arm device (IGBT) of the first switch 4 and a second power converter 2 based on an output signal Vce4 from the first voltage detector 7. The output signal Vce4 from the first voltage detector 7 is compared with a reference voltage vcer in a comparator 8a. This reference voltage vcer is a voltage corresponding to VceR shown in FIGS. 2 and 3. It is set to an appropriate value between the collector voltage Vce4 of the device (IGBT) in the first switch 4 and the collector voltage Vce2X of each arm device in the second power converter 2. An output of the comparator 8a and a gate command signal S4′ for the first switch 4 given from a higher-order control circuit (not shown) are ANDed by an AND circuit 8b of which output is sent to a hold circuit 8c. An output of the hold circuit 8c is delivered to AND circuits 8d, 8e, 8f, in which the output is ANDed with the gate command signal S4′ given from the higher-order control circuit (not shown) and gate command signals S2U′ and S2X′ for arms 2U and 2X of the second power converter 2, respectively. Output signals (gate signals) S4, S2U and S2X of the AND circuits 8d, 8e, 8f are delivered to gate circuits 5, 6U and 6X, respectively.

Operation of the power conversion apparatus of this embodiment will now be described. When a dc short-circuit current Is flows through a path shown by broken lines in FIG. 4, the collector voltage Vce4 of the IGBT in the first switch 4 increases according to voltage distribution characteristics shown in FIGS. 2 and 3. When the voltage value exceeds the reference voltage vcer, the output of the comparator 8a is inverted to a high (H) level. On the other hand, because the device in the first switch 4 is always conducting, the gate command signal S4′ is held at the H level so that the output of the AND circuit 8b is inverted to the H level and the output of the hold circuit 8c is held in a low (L) state, inverted from an H state. Consequently, the gate signals S4, S2U and S2X which are all forcibly maintained in the L state are sent to the first switch 4 and the arms 2U and 2X of the second power converter 2 and turn off their respective IGBT devices.

Although FIG. 4 shows the arm device of the second power converter 2 for one phase only for simplicity, it goes without saying that the healthy devices of the other phases are also turned off at the same time.

In addition, although the first power converter 1 is shown as being an externally commutated converter formed of diode rectifiers for the sake of simplicity in FIG. 4, it may be a self-commutated converter like the second power converter 2. In the latter case, the same advantageous effect as described above would be obtained by turning off the devices by the dc short-circuit control circuit 8 when a dc short circuit has occurred.

Because the dc short-circuit current can be quickly interrupted by monitoring the voltage appearing on the first switch 4 and turning off the device of the first switch 4 and all the arm devices of the second power converter 2 upon detecting the occurrence of a dc short circuit as described above, it is possible to protect the power conversion apparatus against the dc short circuit with high reliability and at low cost.

### Fourth Embodiment

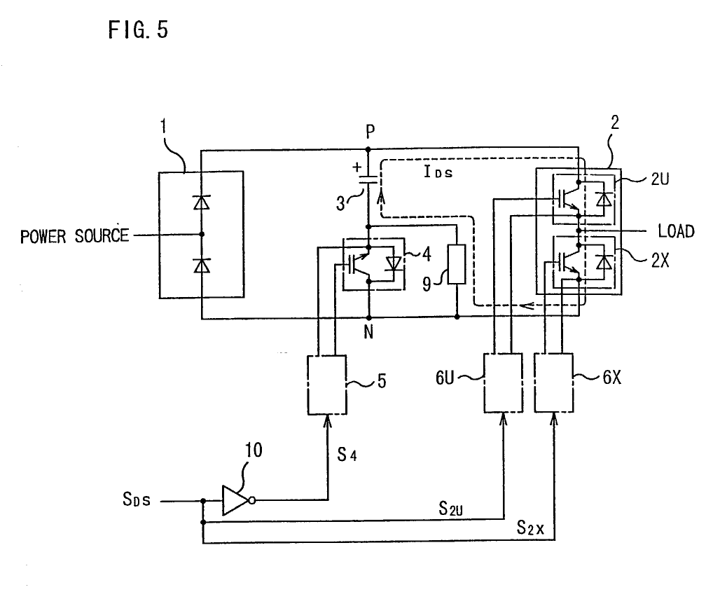

Shown in FIG. 5 is a power conversion apparatus according to a fourth embodiment of the invention, which is related to the first embodiment. This embodiment pertains particularly to a method of discharging a dc capacitor 3. Referring to the Figure, designated by the numeral 9 is a first discharging resistor connected to both ends of a first switch 4 in parallel therewith. When a discharge command signal SDS is set to an H level, a gate signal S4 entered to the first switch 4 turns to an L level through a NOT circuit 10, turning off the first switch 4. On the other hand, devices in arms (2U and 2X, for example) for only one phase in a second power converter 2 are turned on simultaneously. Consequently, a discharge current IDS flows through a path shown by broken lines in FIG. 5 whereby the dc capacitor 3 can be discharged. The reason why the arm devices for only one phase of the second power converter 2 are turned on is as follows. If the devices of all phases of the second power converter 2 are turned on simultaneously under conditions in which a naturally decelerating motor is connected as a load, for example, the second power converter 2 would short-circuit the motor, causing an ac short-circuit current to flow due to a residual electromotive force of the motor. Thus, it is necessary to turn on the arm devices of only one phase to prevent short-circuiting the motor.

Because the first discharging resistor 9 is connected to both ends of the first switch 4 and the arm devices of only one phase of the second power converter 2 are turned on while turning off the first switch 4 as described above, it is possible to obtain low-cost discharge means featuring high reliability.

In a case where the load is not a rotating machine like the motor but is a load which does not accumulate energy, the aforementioned structure of the embodiment may be so modified that the devices of all phases of the second power converter 2 would be turned on.

### Fifth Embodiment

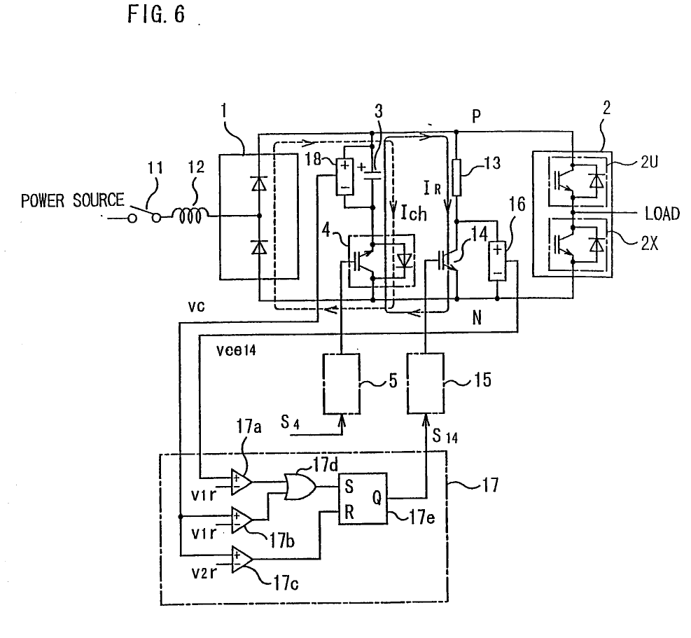

Shown in FIG. 6 is a power conversion apparatus according to a fifth embodiment of the invention, which is related to the first embodiment. This embodiment pertains particularly to a method of charging a dc capacitor 3. Referring to the Figure, designated by the numeral 11 is a switch provided at the power source side, designated by the numeral 12 is a reactor connected between the switch 11 and a first power converter 1, designated by the numerals 13 and 14 are a second discharging resistor and a second switch (using a third switched valve device), respectively, which are connected in series between P and N terminals, designated by the numeral 16 is a third voltage detector parallel-connected to both ends of the second switch 14, designated by the numeral 17 is a charge control circuit for controlling the second switch 14, and designated by the numeral 18 is a second voltage detector parallel-connected to both ends of the dc capacitor 3.

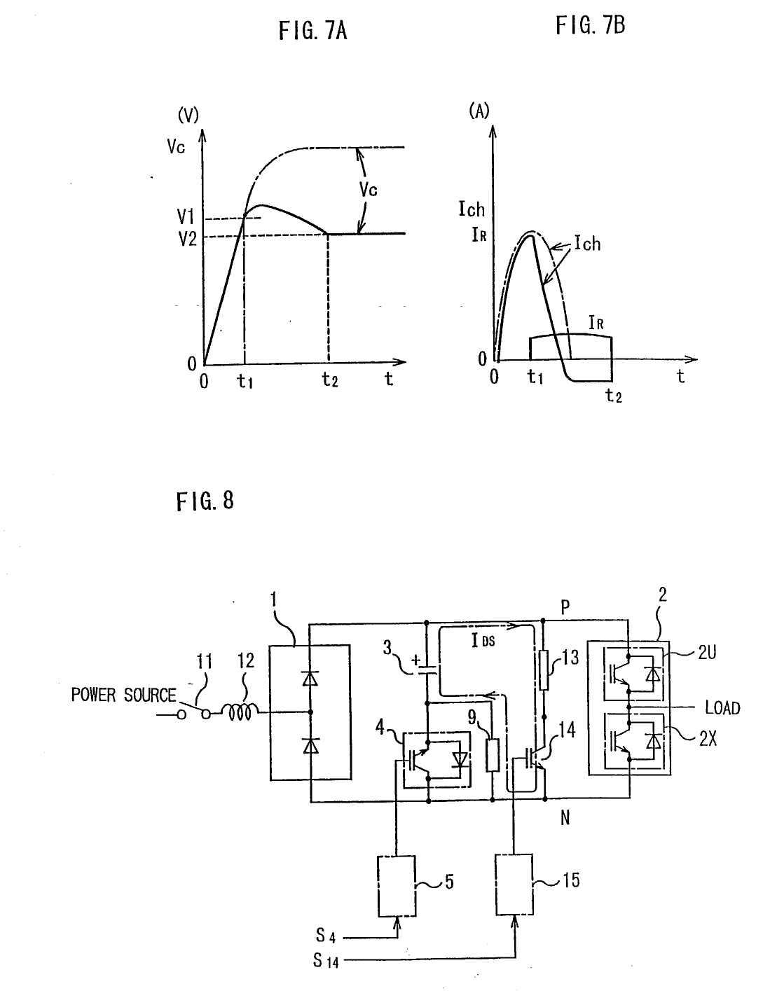

Operation of the power conversion apparatus of this embodiment will now be described. If the switch 11 is closed when a gate signal S4 entered to a first switch 4 is in an ON command state and the first switch 4 is in an ON state, a charge current Ich for charging the dc capacitor 3 flows through a path shown by broken lines in FIG. 6 through the reactor 12 and the first power converter 1. Shown in FIGS. 7A and 7B is how waveforms of a voltage Vc applied across and the charge current Ich flowing through the dc capacitor 3 change in this situation. Referring to the Figures, if there is no second switch 14, the dc capacitor 3 would be charged to approximately twice as high as a peak value of a source voltage as shown by an alternate long and short dashed line due to the phenomenon of resonance between the reactor 12 and the dc capacitor 3, causing a possibility of destroying the devices of the first power converter 1 and the second power converter 2. Under these circumstances, the second discharging resistor 13 and the second switch 14 are provided to prevent such overcharging. When the voltage Vc across the dc capacitor 3 exceeds a voltage level V2 corresponding to a rated dc voltage and reaches a voltage level V1 which is set slightly higher than the voltage level V2 at time t1 as shown in FIG. 7A, the second switch 14 is turned on. Then, the charge voltage Vc decreases as shown by a solid line waveform in the Figure.

To describe the aforementioned control method more specifically, comparators 17a and 17b of the charge control circuit 17 compare output signals vc and vce14 of the second voltage detector 18 and the third voltage detector 16 with a reference voltage v1r, respectively, and if either output signal exceeds this reference voltage v1r, an output signal S14 of a hold circuit 17e is maintained at an H level through an OR circuit 17d and the second switch 14 is turned on via a gate circuit 15.

Subsequently, when the voltage Vc across the dc capacitor 3 decreases due to a discharge current IR and reaches the voltage level V2, a comparator 17c compares the output signal vc of the second voltage detector 18 and a reference voltage v2r corresponding to the voltage level V2 and resets the hold circuit 17e. At this point, the output signal S14 of the hold circuit 17e is inverted to an L level and the second switch 14 is turned off.

According to the invention, a transformer may be employed as a substitute for the reactor 12, and the same advantageous effect as described above would be achieved even when a self-commutated converter is used as the first power converter 1.

As can be understood from the foregoing discussion, it is possible to prevent overcharge of the dc capacitor 3 and obtain low-cost charging means featuring high reliability as a series-connected unit including the second discharging resistor 13 and the second switch 14 is provided between the P and N terminals of the dc circuit and the second switch 14 is controlled such that it is turned on when the voltage across the dc capacitor 3 exceeds a slightly higher set value than the rated dc voltage and turned off when the voltage across the dc capacitor 3 decreases down to the rated dc voltage.

While the voltage across the dc capacitor 3 is detected by using the second voltage detector 18 and the third voltage detector 16 to enhance the reliability of detection the aforementioned structure in FIG. 6, the structure may be so modified to detect the voltage across the dc capacitor 3 using only the second voltage detector 18.

### Sixth Embodiment

Shown in FIG. 8 is a power conversion apparatus according to a sixth embodiment of the invention, which is related to the first embodiment. This embodiment pertains particularly to a method of discharging a dc capacitor 3. While the power conversion apparatus of the fourth embodiment shown in FIG. 5 discharges the dc capacitor 3 by using the second power converter 2, the power conversion apparatus of the sixth embodiment is provided with a first discharging resistor 9 connected in parallel with a first switch 4 and discharges the dc capacitor 3 by using a second discharging resistor 13 and a second switch 14 connected between P and N terminals.

Operation of the power conversion apparatus of this embodiment will now be described. When the second switch 14 is turned on under conditions in which a switch 11, a second power converter 2 and the first switch 4 are off, a discharge current IDS flows through a path shown by alternate long and short dashed lines, thereby discharging the dc capacitor 3. The period of time required for discharging the dc capacitor 3 can be adjusted by varying the value of resistance of the first discharging resistor 9.

Although it is necessary to cause all the arm devices of the second power converter 2 to conduct simultaneously and this operation requires high reliability in the fourth embodiment of FIG. 5, it is only necessary to cause a third switched valve device of the second switch 14 to conduct, so that operation of discharging the dc capacitor 3 becomes more simple and reliable.

According to the invention, a transformer may be employed as a substitute for the reactor 12, and the same advantageous effect as described above would be achieved even when a self-commutated converter is used as the first power converter 1.

Because this power conversion apparatus is constructed such that the second switch 14 is turned on to discharge the dc capacitor 3 through the first discharging resistor 9 and the second discharging resistor 13 under conditions in which the first switch 4 is turned off as described above, it is possible to adjust the discharging time and obtain low-cost discharge means featuring high reliability.

### Seventh Embodiment

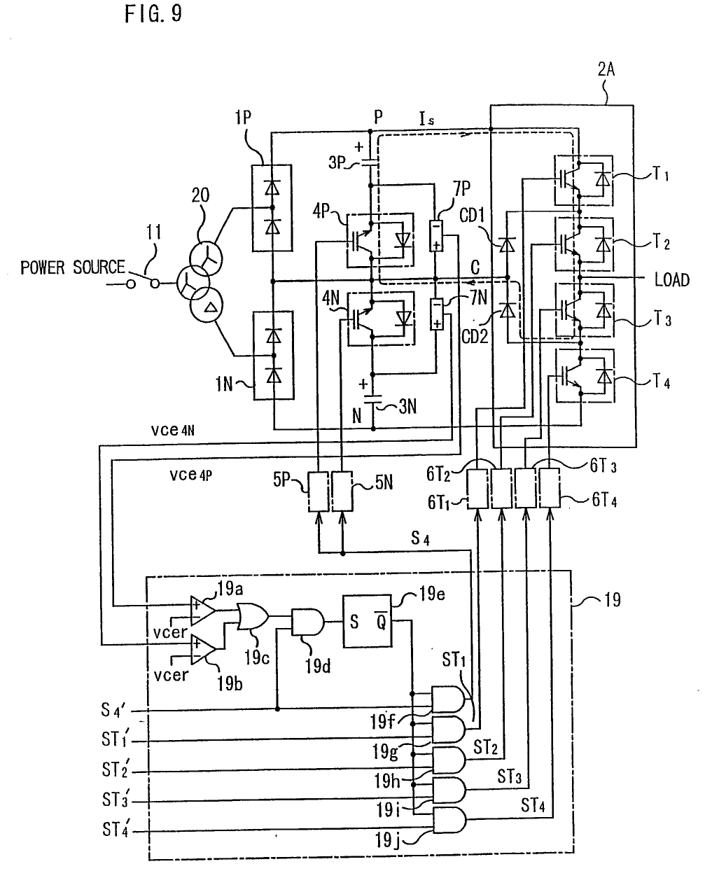

Shown in FIG. 9 is a power conversion apparatus according to a seventh embodiment of the invention. While the foregoing discussion of the first embodiment has dealt with the structure in which the second power converter 2 is a 2-level inverter having the P and N terminals, this seventh embodiment employs a 3-level inverter having P, C and N terminals as a dc circuit. Referring to FIG. 9, designated by the numeral 20 is a multiphase transformer of which secondary and tertiary sides has a phase difference of 30° and are connected to a first power converter 1P of a positive (P) side and a first power converter 1N of a negative (N) side, respectively, forming a so-called 12-phase rectifier circuit. The first power converter 1P and the first power converter 1N of the P and N sides are connected in series with their both extreme ends connected to the P and N terminals, respectively, and their intermediate connecting point connected to the C terminal. Designated by the numeral 2A is a second power converter constructed of a 3-level inverter, in which arms T1 to T4 individually formed of voltage-driven switched valve devices together constitute an output circuit for one phase. Specifically, these arms T1-T4 are IGBTs connected in series between the P and N terminals, each of the IGBTs being associated with a diode connected in reverse parallel. Designated by the symbols CD1 and CD2 are clamping diodes which are connected in series between an intermediate connecting point between the arms T1 and T2 and an intermediate connecting point between the arms T3 and T4, an intermediate connecting point between the clamping diodes CD1 and CD2 being connected to the C terminal.

Designated by the numerals 3P and 4P are a dc capacitor and a first switch of the P side, respectively, which are connected in series between the P and C terminals. Similarly, designated by the numerals 3N and 4N are a dc capacitor and a first switch of the N side, respectively, which are connected in series between the C and N terminals. Designated by the numerals 7P and 7N are first voltage detectors of the P and N sides, which are parallel-connected to the first switches 4P and 4N of the P and N sides, respectively. Designated by the numerals 5P and 5N are gate circuits connected to gates of the first switches 4P and 4N of the P and N sides, respectively, the gate circuits 5P and 5N having the same configuration and function as the gate circuit 5 of the first embodiment. Designated by the numerals 6T1 to 6T4 are gate circuits connected to gates of the devices in the arms T1-T4 of the second power converter 2A, respectively, the gate circuits 6T1 to 6T4 having the same configuration and function as the gate circuits 6U and 6X of the first embodiment. Further, designated by the numeral 19 is a dc short-circuit control circuit which has almost the same function as the dc short-circuit control circuit 8 of the third embodiment.

Operation of the power conversion apparatus of this embodiment will now be described. When the devices in the arms T1 to T3 of the second power converter 2A conduct and a dc short circuit occurs between the P and C terminals, a dc short-circuit current Is flows through a path shown by broken lines in FIG. 9. If a collector voltage Vce4P of the first switch 4P of the P side increases and exceeds VceR as shown in FIG. 2 at this time, an output of a comparator 19a of the dc short-circuit control circuit 19 is inverted to the H level and an output of a hold circuit 19e is held in the L state so that the devices in the first switches 4P and 4N of the P and N sides, respectively, and those in the arms T1-T4 of the second power converter 2A are turned off. Also, if the devices in the arms T2 to T4 of the second power converter 2A conduct and a dc short circuit occurs between the C and N terminals, a collector voltage Vce4N of the first switch 4N of the N side increases. When the collector voltage Vce4N exceeds VceR as shown in FIG. 2, an output of a comparator 19b of the dc short-circuit control circuit 19 is inverted to the H level and an output of the hold circuit 19e is held in the L state so that the devices in the first switches 4P and 4N of the P and N sides, respectively, and those in the arms T1-T4 of the second power converter 2A are turned off. Also, if the devices in the arms T1 to T4 of the second power converter 2A conduct and a dc short circuit occurs between the P and N terminals, the collector voltages Vce4P and Vce4N of the first switches 4P and 4N of the P and N sides increase, respectively. When the collector voltages Vce4P and Vce4N exceed VceR as shown in FIG. 2, the outputs of the comparators 19a and 19b of the dc short-circuit control circuit 19 are inverted to the H level and the output of the hold circuit 19e is held in the L state so that the devices in the first switches 4P and 4N of the P and N sides, respectively, and those in the arms T1-T4 of the second power converter 2A are turned off.

While FIG. 9 shows a circuit configuration in which the transformer 20 and the first switches 4P and 4N of the P and N sides constitute a 12-phase rectifier circuit for the sake of simplicity, a multiphase rectifier circuit operating on 24 or more phases may be employed to configure a power conversion apparatus according to the invention to obtain the same advantageous effect as described above.

Because the dc short-circuit current can be quickly interrupted by monitoring the voltages across the first switches 4P and 4N of the P and N sides and turning off the devices in the first switches 4P and 4N of the P and N sides and in all the arms T1-T4 of the second power converter 2A upon detecting the occurrence of a dc short circuit as described above, it is possible to protect the power conversion apparatus against the dc short circuit with high reliability and at low cost.

### Eighth Embodiment

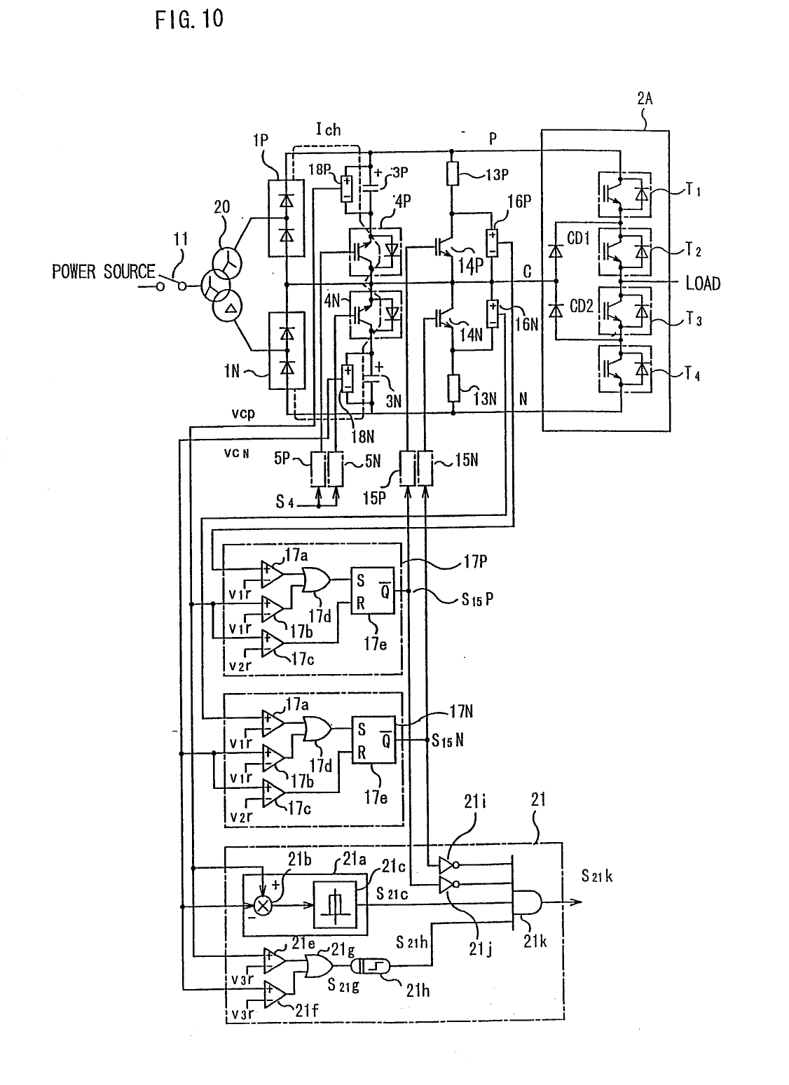

Shown in FIG. 10 is a power conversion apparatus according to an eighth embodiment of the invention, which is related to the first embodiment. This embodiment pertains particularly to a method of charging dc capacitors 3P and 3N of P and N sides, respectively. Referring to the Figure, designated by the numerals 13P and 14P are a second discharging resistor of the P side and a second switch of the P side, respectively, which are connected in series between P and C terminals, designated by the numeral 16P is a third voltage detector of the P side parallel-connected to both ends of the second switch 14P of the P side, and designated by the numeral 18P is a second voltage detector of the P side parallel-connected to both ends of the dc capacitor 3P of the P side. Designated by the numerals 13N and 14N are a second discharging resistor of the N side and a second switch of the N side, respectively, which are connected in series between the C and N terminals, designated by the numeral 16N is a third voltage detector of the N side parallel-connected to both ends of the second switch 14N of the N side, and designated by the numeral 18N is a second voltage detector of the N side parallel-connected to both ends of the dc capacitor 3N of the N side. Designated by the numerals 17P and 17N are charge control circuits of the P and N sides for controlling the second switches 14P and 14N of the P and N sides, respectively, and designated by the numeral 21 is an end-of-charge detecting circuit.

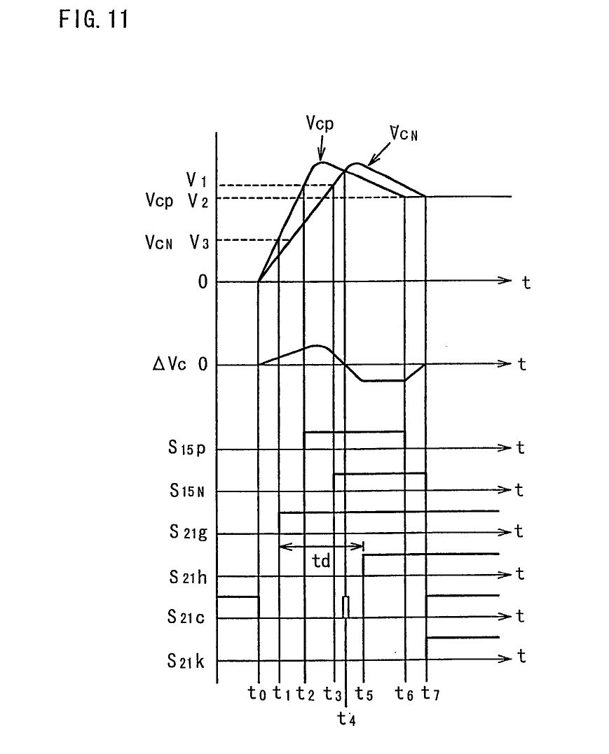

Operation of the power conversion apparatus of this embodiment will now be described. If a switch 11 is closed when gate signals S4 entered to first switches 4P and 4N of the P and N sides are in an ON command state and the first switches 4P and 4N of the P and N sides are in an ON state, a charge current Ich for charging the dc capacitors 3P and 3N of the P and N sides flows through a path shown by broken lines in FIG. 10 through a transformer 20 and first power converters 1P, 1N of the P and N sides. Shown in FIG. 11 is how waveforms of voltages Vc across the dc capacitors 3P and 3N of the P and N sides change in this situation. Because there is a phase difference of 30° in output voltages of secondary and tertiary sides of the transformer 20, voltages VcP and VcN across the dc capacitors 3P and 3N of the P and N sides show different variations with time, respectively, as depicted in the Figure.

For this reason, the second switches 14P and 14N of the P and N sides are individually controlled by the separate charge control circuits 17P and 17N having the same operational feature, respectively, as previously described with reference to the charge control circuit 17 of the fifth embodiment. The end-of-charge detecting circuit 21 has a voltage matching detection circuit 21a for detecting whether the voltages VcP and VcN across the dc capacitors 3P and 3N of the P and N sides have matched with each other. When they match, an output signal S21c of the voltage matching detection circuit 21a is set to the H level. The voltage matching detection circuit 21a is formed of a subtracter 21b and a 0-level detector 21c, for example. The end-of-charge detecting circuit 21 further includes comparators 21e and 21f for detecting that the voltages VcP and VcN across the dc capacitors 3P and 3N have exceeded a lower-limit dc voltage V3 shown in FIG. 11 at which the apparatus is operable as well as a delay circuit 21h which outputs a delay signal S21h based on output signals of the comparators 21e and 21f entered through an OR circuit 21g.

Operation of the end-of-charge detecting circuit 21 is now be described referring to FIG. 11. At time t1 when either the voltage VcP across the dc capacitor 3P of the P side or the voltage VcN across the dc capacitor 3N of the N side exceeds a set voltage level V3, an output signal S21g of the OR circuit 21g turns to the H level, and the delay signal S21h of the delay circuit 21h turns to the H level at time t5 a delay time td later than the time t1. Output signals S15P and S15N of the charge control circuits 17P and 17N of the P and N sides go to the H level during a period of time t2 to t6 and a period of time t3 to t7, thereby turning on the second switches 14P and 14N of the P and N sides, respectively. A voltage difference ΔVc between the voltages VcP and VcN across the dc capacitors 3P and 3N of the P and N sides is as illustrated in FIG. 11. As the output signal S21c of the voltage matching detection circuit 21a momentarily turns to the H level, detection of the matching of the voltages VcP and VcN due to such transient variations is disabled by the delay circuit 21h. Designated by the numeral 21k in FIG. 10 is an AND circuit which ANDs inverted signals of the output signals S15P and S15N of the charge control circuits 17P and 17N, the output signal S21c of the voltage matching detection circuit 21a and the delay signal S21h of the delay circuit 21h and, at the time t7 when the matching of the voltages VcP and VcN is detected continuously, outputs an end-of-charge signal S21k which is set to the H level. A second power converter 2A is set to operate when this end-of-charge signal S21k turns to the H level.

As can be understood from the foregoing discussion, it is possible to prevent overcharge of the dc capacitor 3P (3N) as a series-connected unit including the second discharging resistor 13P (13N) and the second switch 14P (14N) is provided between the P and C (C and N) terminals of the dc circuit and the second switch 14P (14N) is individually controlled such that it is turned on when the voltage across the dc capacitor 3P (3N) connected between the P and C (C and N) terminals of the dc circuit exceeds a set value slightly higher than a rated dc voltage and turned off when the voltage across the dc capacitor 3 decreases down to the rated dc voltage. In addition, because there is provided the voltage matching detection circuit 21a for detecting whether the voltages VcP and VcN across the two dc capacitors 3P and 3N have continuously matched, it is possible to set the second power converter 2A to operate quickly, so that low-cost charging means featuring high reliability is obtained.

### Ninth Embodiment

Shown in FIG. 12 is a power conversion apparatus according to a ninth embodiment of the invention, which is related to the seventh embodiment. This embodiment pertains particularly to means for suppressing following (residual) current from the power source side after the occurrence of a short-circuit current and a method of charging dc capacitors 3P and 3N of P and N sides, respectively. Referring to the Figure, designated by the numeral 22P is a third switch of the P side formed of a fourth switched valve device which is connected between a C terminal and a negative terminal of a first power converter 1P of the P side. Designated by the numeral 23P is a current-limiting resistor of the P side parallel-connected to the third switch 22P of the P side. Designated by the numeral 22N is a third switch of the N side formed of a fourth switched valve device which is connected between a C terminal and a positive terminal of a first power converter 1N of the N side. Designated by the numeral 23N is a current-limiting resistor of the N side parallel-connected to the third switch 22N of the N side.

Operation of the power conversion apparatus of this embodiment will now be described. If devices in arms T1 to T3 of a second power converter 2A conduct and a dc short circuit occurs between P and C terminals, a dc short-circuit current Is flows through a path shown by broken lines in FIG. 12. It would be possible to suppress this dc short-circuit current Is by turning off a first switch 4P of the P side in the same manner as in the seventh embodiment. If the devices in the arms T1-T3 of the second power converter 2A are all destroyed at worst, however, there can arise a possibility that their destruction leads to a secondary failure of other healthy devices, such as a clamping diode CD2 or devices in the first power converter 1P of the P side, due to overcurrent. This is because a following current ISL flows from the power source side through a path shown by alternate long and two short dashed lines until a switch 11 is opened when the devices in the arms T1-T3 have been destroyed.

Under these circumstances, while the third switches 22P and 22N of the P and N sides are kept normally in an ON state during operation, they are turned off at the same time as the first switch 4P of the P side and a first switch 4N of the N side are turned off, so that the following current ISL from the power source side can be limited by the current-limiting resistors 23P and 23N.

It is also possible to utilize the third switches 22P and 22N and the current-limiting resistors 23P and 23N of the P and N sides when charging the dc capacitors 3P and 3N of the P and N sides, respectively. Specifically, when closing the switch 11, the third switches 22P and 22N of the P and N sides are turned off and the dc capacitor 3P of the P side, for example, is charged by causing a charge current Ich to flow through the path shown by the alternate long and short dashed lines. Since the current-limiting resistor 23P is connected in series with the dc capacitor 3P in this case, it is possible to alleviate the phenomenon of resonance which would occur between an inductance component of a transformer 20 and the dc capacitor 3P and prevent overcharge of the dc capacitor 3P. When the charging of the dc capacitors 3P and 3N of the P and N sides has subsequently finished, the third switches 22P and 22N of the P and N sides are turned on and the second power converter 2A resumes its operation.

While the same advantageous effect is produced when the third switches 22P and 22N of the P and N sides are provided on the P and N terminal sides, respectively, an effect of reducing a possibility of malfunction due to the influence of noise is achieved if they are provided on the side of the C terminal like the first switches 4P and 4N of the P and N sides as shown in FIG. 12, because the electric potential of a dc line C relative to the ground potential is lowered by as much as the voltage of the dc circuit with reference to the electric potential of the P and N terminals relative to the ground potential.

As the following current ISL from the power source side in the event of a dc short circuit can be limited and overcharging of the dc capacitors 3P and 3N of the P and N sides can be prevented with the provision of the third switches 22P and 22N series-connected to the first power converters 1P and 1N and the current-limiting resistors 23P and 23N parallel-connected to the third switches 22P and 22N, respectively, as described above, it is possible to obtain a low-cost power conversion apparatus featuring high reliability.

It is to be pointed out that the third switches 22P and 22N and the current-limiting resistors 23P and 23N are applicable not only to the 3-level power conversion apparatus but also to the 2-level power conversion apparatus described in the foregoing embodiments on the ground of the same concept, thereby achieving the equivalent advantageous effect.

### Tenth Embodiment

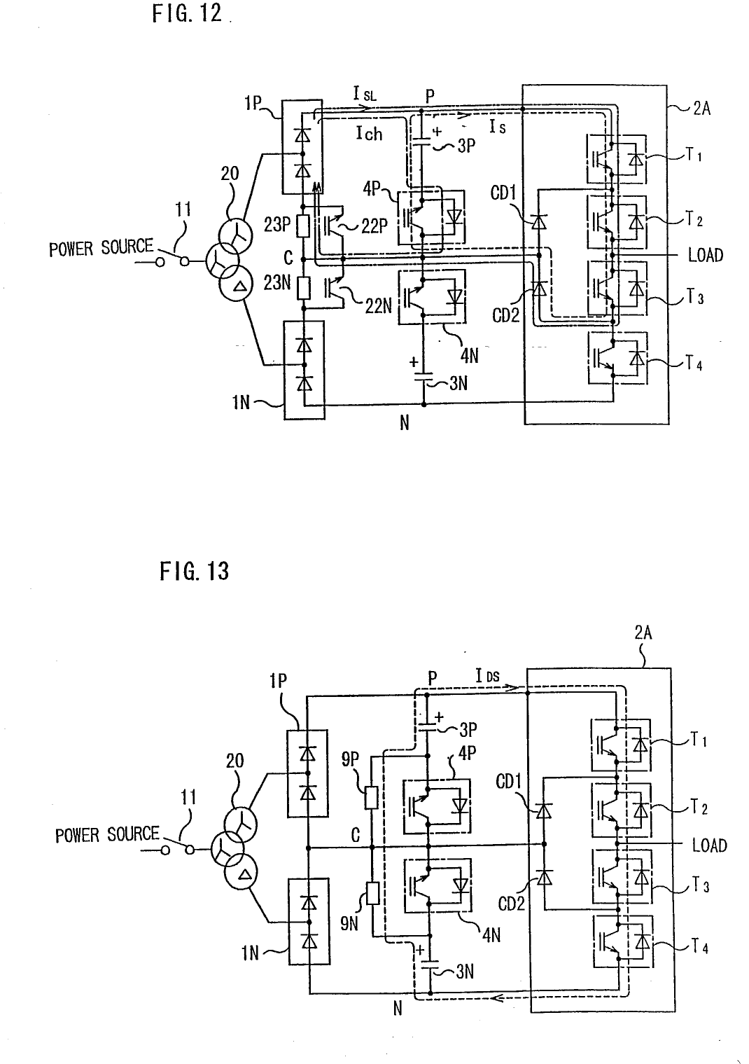

Shown in FIG. 13 is a power conversion apparatus according to a tenth embodiment of the invention, which is related to the seventh embodiment. This embodiment pertains particularly to a method of discharging dc capacitors 3P and 3N of P and N sides, respectively. Referring to the Figure, designated by the numerals 9P and 9N are first discharging resistor of the P and N sides which are parallel-connected to first switches 4P and 4N of the P and N sides, respectively.

After stopping the operation, a discharge current IDS is caused to flow through a path shown by broken lines in FIG. 13 by turning off the first switches 4P and 4N of the P and N sides and turning on devices in arms T1 to T4 for one phase of a second power converter 2A, so that the dc capacitors 3P and 3N of P and N sides are discharged. It is possible to obtain a low-cost power conversion apparatus featuring high reliability by configuring a discharge path as described above.

### Eleventh Embodiment

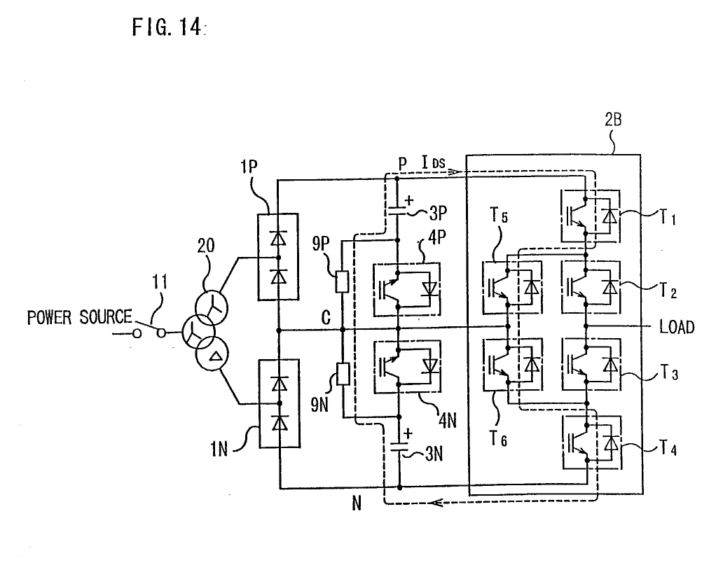

Shown in FIG. 14 is a power conversion apparatus according to an eleventh embodiment of the invention. This embodiment pertains to a method of discharging dc capacitors 3P and 3N of P and N sides, respectively, when employing a second power converter 2B which is a 3-level inverter differing from the second power converter 2A described in the seventh embodiment. Referring to the Figure, designated by the numerals T5 and T6 are clamping devices, or IGBTs more specifically, provided as substitutes for the earlier-mentioned clamping diodes CD1 and CD2, each IGBT being formed of a voltage-driven switched valve device (fifth switched valve device) and a diode connected together in reverse parallel like arms T1 to T4.

When a dc short circuit has occurred, it is possible to suppress a dc short-circuit current by turning off first switches 4P and 4N of P and N sides and the devices in the arms T1 to T4 of the second power converter 2B as well as the clamping devices T5 and T6 at the same time.

Possible paths for dc short-circuit currents in this situation would be the one through T1-T2-T3-T6, the one through TL-T5, the one through T5-T2-T3-T4 and the one through T6-T4.

After stopping the operation subsequently, a discharge current IDS is caused to flow through a path shown by broken lines in FIG. 14 by turning off the first switches 4P and 4N of the P and N sides and turning on the devices in the arms T1 to T4 for one phase of the second power converter 2B, so that the dc capacitors 3P and 3N of P and N sides are discharged. It is possible to obtain a low-cost power conversion apparatus featuring high reliability by configuring a discharge path as described above.

### Twelfth Embodiment

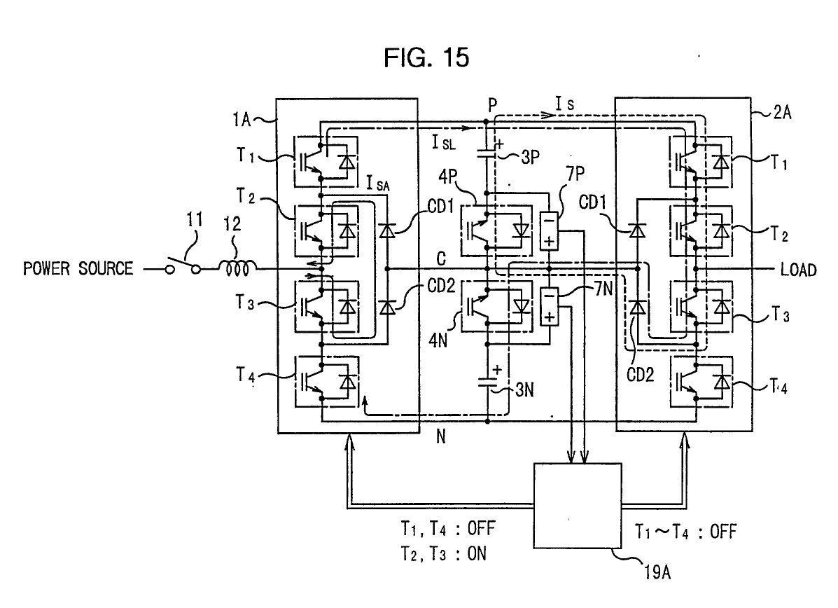

Shown in FIG. 15 is a power conversion apparatus according to a twelfth embodiment of the invention. This embodiment pertains to a method of dc short-circuit protection applied to a case where a self-commutated converter (first power converter 1A) using sixth switched valve devices and having the same configuration as a second power converter 2A is substituted for the first power converters 1P and 1N described in the seventh embodiment. Referring to the Figure, when devices in arms T1 to T3 of the second power converter 2A conduct, a dc short-circuit current Is flows through a path shown by broken lines, thereby discharging a dc capacitor 3P of the P side. It would be possible to suppress this dc short-circuit current Is by turning off all arm devices of first switches 4P and 4N of the P and N sides and those of the second power converter 2A. If, however, the devices in the arms T1-T3 of the second power converter 2A are destroyed at worst, a following current ISL would flow from a power source side through a path shown by alternate long and short dashed lines by way of diodes in arm devices of a first power converter 1A. As a dc capacitor 3N of the N side is overcharged to twice as high as a rated dc voltage or more by the following current ISL in this situation, there can arise a high possibility of destruction of other healthy devices due to overvoltage.

Designated by the numeral 19A in FIG. 15 is a dc short-circuit control circuit having the same configuration and function as the earlier-mentioned dc short-circuit control circuit 19. Upon detecting a dc short circuit, it turns off all the arm devices of the first switches 4P and 4N of the P and N sides and those of the second power converter 2A as well as devices in arms T1 and T4 for all phases of the first power converter 1A and turns on devices in arms T2 and T3 for all phases of the first power converter 1A to interrupt the following current ISL. More particularly, because an ac short-circuit current ISA flows through the path shown by the alternate long and two short dashed lines by turning on the devices in the arms T2 and T3 for all phases of the first power converter 1A to forcibly form an ac short-circuit path (which is practically short-circuit paths bridging different phases), the voltage between both ends of each device in the arms T2 and T3 of the first power converter 1A becomes zero, so that charging of the dc capacitor 3N of the N side is interrupted.

It is to be noted in connection with the above discussion that all the arm devices of the second power converter 2A are turned off for suppressing the following current ISL from a load side when there exists a voltage source.

According to the invention, the same advantageous effect as described above would be obtained even when a transformer is employed as a substitute for the reactor 12.

When the first power converter 1A has the same structure as the 3-level inverter described above, it is possible to prevent overcharge of the dc capacitors 3P and 3N by turning off the devices in the outside arm T1 and T4 of all phases and forcibly turning on the devices in the inside arm T2 and T3 of all phases at the occurrence of a dc short circuit. It is therefore possible to obtain a low-cost power conversion apparatus featuring high reliability.

### Thirteenth Embodiment

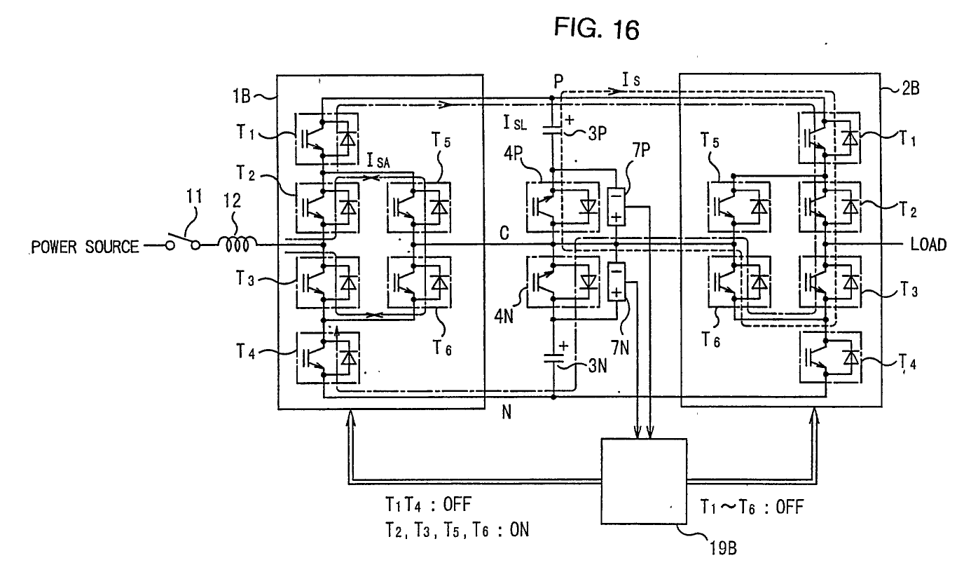

Shown in FIG. 16 is a power conversion apparatus according to a thirteenth embodiment of the invention. Whereas the first power converter 1A and the second power converter 2A are both constructed of the 3-level inverters in the twelfth embodiment as shown in FIG. 9, this embodiment pertains to a dc short-circuit protection method used when a first power converter 1B and a second power converter 2B are both constructed of 3-level inverters as shown in FIG. 14. Referring to the Figure, when devices in arms T1 to T3 of the second power converter 2B conduct, a dc short-circuit current Is flows through a path shown by broken lines, thereby discharging a dc capacitor 3P of the P side. It would be possible to suppress this dc short-circuit current Is by turning off all arm devices of first switches 4P and 4N of the P and N sides and those of the second power converter 2B. If, however, the devices in the arms T1-T3 of the second power converter 2B are destroyed at worst, a following current ISL would flow from a power source side through a path shown by alternate long and short dashed lines by way of diodes in the arm devices of the first power converter 1B. As a dc capacitor 3N of the N side is overcharged to twice as high as a rated dc voltage or more by the following current ISL in this situation, there can arise a high possibility of destruction of other healthy devices due to overvoltage.

Designated by the numeral 19B in FIG. 16 is a dc short-circuit control circuit having the same configuration and function as the earlier-mentioned dc short-circuit control circuit 19. Upon detecting a dc short circuit, it turns off all the arm devices of the first switches 4P and 4N of the P and N sides and those of the second power converter 2B as well as devices in arms T1 and T4 for all phases of the first power converter 1B and turns on devices in arms T2, T3, T5 and T6 for all phases of the first power converter 1B to interrupt the following current ISL, wherein seventh switched valve devices are used as the arms T5 and T6. More particularly, because an ac short-circuit current ISA flows through the path shown by the alternate long and two short dashed lines by turning on the devices in the arms T2, T3, T5 and T6 for all phases of the first power converter 1B to forcibly form an ac short-circuit path (which is practically short-circuit paths bridging different phases), the voltage between both ends of each device in the arms T2 and T3 of the first power converter 1B becomes zero, so that charging of the dc capacitor 3N of the N side is interrupted. Since arms T5 and T6 of the first power converter 1B conduct in two opposite directions in this situation, the ac short-circuit current ISA flowing through the arms T2, T3, T5 and T6 for all phases of the first power converter 1B is decreased compared to the case of the first power converter 1A of the preceding embodiment.

According to the invention, the same advantageous effect as described above would be obtained even when a transformer is employed as a substitute for the reactor 12.

When the first power converter 1B is a 3-level inverter formed of the arms T1 to T6 as described above, it is possible to prevent overcharge of the capacitors 3P and 3N by turning off the devices in the outside arm T1 and T4 of, all phases and forcibly turning on the devices in the inside arm T2 and T3 of all phases as well as the arms (clamping devices) T5 and T6 of all phases at the occurrence of a dc short circuit. It is therefore possible to obtain a low-cost power conversion apparatus featuring high reliability.

### Fourteenth Embodiment

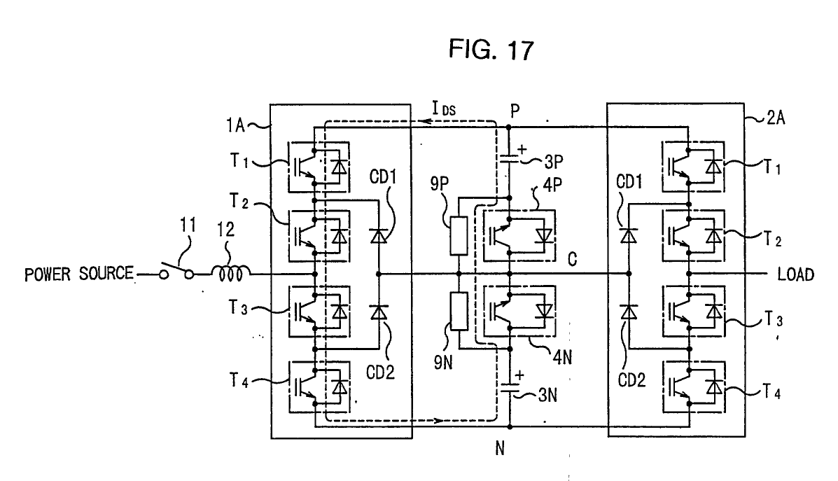

Shown in FIG. 17 is a power conversion apparatus according to a fourteenth embodiment of the invention, which is related to the twelfth embodiment. This embodiment pertains to a method of discharging dc capacitors 3P and 3N of P and N sides, respectively. Referring to the Figure, first switches 4P and 4N of the P and N sides are turned off after stopping the operation and, with a switch 11 opened, devices in arms T1 to T4 for one phase of a first power converter 1A are turned on, so that a discharge current IDS flows through a path shown by broken lines in FIG. 17 and the dc capacitors 3P and 3N are discharged simultaneously.

According to the invention, the same advantageous effect as described above would be obtained even when a transformer is employed as a substitute for the reactor 12.

Since this embodiment is configured to discharge the dc capacitors 3P and 3N by opening the switch 11 and turning on the devices in the arms T1 to T4 for one phase of the first power converter 1A as described above, it is possible to obtain a low-cost power conversion apparatus featuring high reliability totally free of the influence of the power source side.

### Fifteenth Embodiment

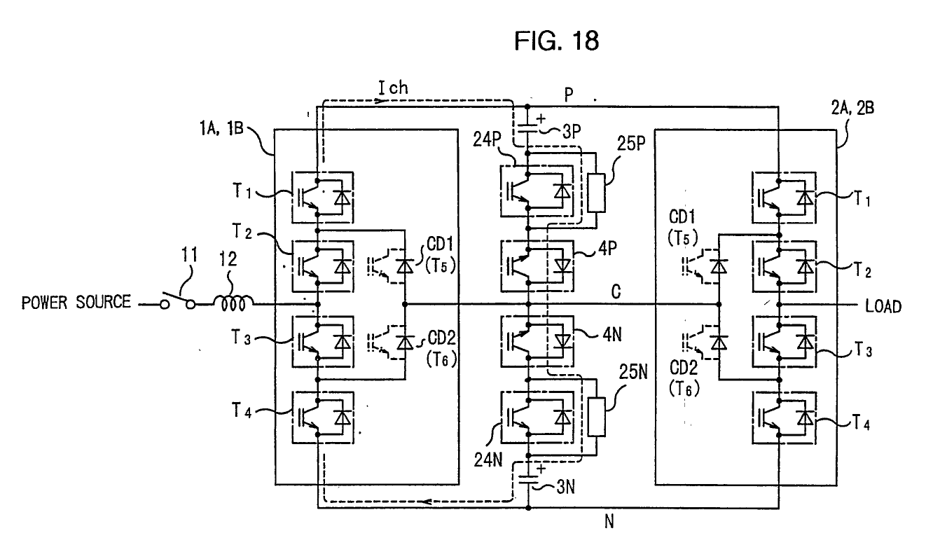

Shown in FIG. 18 is a power conversion apparatus according to a fifteenth embodiment of the invention, which is related to the twelfth and thirteenth embodiments. This embodiment pertains to a method of charging dc capacitors 3P and 3N of P and N sides, respectively. Referring to the Figure, designated by the numerals 24P and 24N are fourth switches of the P and N sides, respectively, each formed of an eighth switched valve device and a diode connected together in reverse parallel. The switched valve devices of the fourth switches 24P, 24N are connected in series with the dc capacitors 3P, 3N of the P and N sides in directions for charging the respective dc capacitors 3P, 3N. Designated by the numerals 25P and 25N are third discharging resistors parallel-connected to the fourth switches 24P, 24N of the P and N sides, respectively. If a switch 11 is closed after turning off the fourth switches 24P, 24N and first switches 4P, 4N of the P and N sides under conditions in which all arm devices of the first power converter 1A are turned off, a charge current Ich flows through a path shown by broken lines in FIG. 18, thereby charging the dc capacitors 3P and 3N simultaneously.

Since the phenomenon of resonance between a reactor 12 and the dc capacitors 3P, 3N is alleviated by the third discharging resistors 25P, 25N, overcharging of the dc capacitors 3P, 3N scarcely occurs. When the charging is completed, the fourth switches 24P, 24N and the first switches 4P, 4N are turned on to thereby resume operation.

According to the invention, a transformer may be employed as a substitute for the reactor 12, and the same advantageous effect as described above would be achieved even when a first power converter 1A depicted in FIG. 18 is replaced by a first power converter 1B having clamping devices T5 and T6.

Since the dc capacitors 3P and 3N are charged with the aid of the third discharging resistors 25P, 25N connected in series with the dc capacitors 3P, 3N and the first switches 4P, 4N to form series-connected units, respectively, and the operation is resumed upon completion of the charging by turning on the fourth switches 24P and 24N parallel-connected to the third discharging resistors 25P and 25N, respectively, it is possible to obtain a low-cost power conversion apparatus featuring high reliability.

### Additional Features

While the invention has thus far been described with reference to its specific embodiments, it can be embodied in various forms of power conversion apparatus which produce additional features and advantages as summarized below, for example.

According to a first additional feature of the invention, the power conversion apparatus includes an ac-dc conversion unit connected to an ac power source to convert an ac power input into dc power and supply the latter to a dc circuit, wherein a first switching unit includes a diode connected in reverse parallel with a first switched valve device.

This feature makes it possible to effectively suppress dc short-circuit current in an ac-ac power conversion system having a dc circuit.

According to a second additional feature of the invention, the power conversion apparatus includes a first voltage detector for detecting a voltage across the first switching unit, wherein the first switched valve device of the first switching unit and second switched valve devices of a dc-ac conversion unit are turned off when an output of the first voltage detector has exceeded a specific set value.

This feature makes it possible to interrupt the dc short-circuit current in a simple and reliable fashion.

According to a third additional feature of the invention, the power conversion apparatus includes a first discharging resistor connected in parallel with the first switching unit. In this power conversion apparatus, a charge accumulated in a dc capacitor of the dc circuit is discharged through the first discharging resistor by turning off the first switched valve device of the first switching unit and turning on the second switched valve devices of the dc-ac conversion unit.

This feature enables simple and reliable discharging of the dc capacitor.

According to a fourth additional feature of the invention, the power conversion apparatus includes a first discharging resistor connected in parallel with the first switching unit, and a series-connected unit including a second switching unit employing a third switched valve device and a second discharging resistor connected between terminals of the dc circuit. In this power conversion apparatus, a charge accumulated in a dc capacitor is discharged through the first and second discharging resistors by turning off the first switched valve device of the first switching unit and turning on the third switched valve device of the second switching unit.

This feature also enables simple and reliable discharging of the dc capacitor.

According to a fifth additional feature of the invention, the power conversion apparatus further includes a second voltage detector for detecting a voltage across the dc capacitor, and a series-connected unit including a second switching unit employing a third switched valve device and a second discharging resistor connected between terminals of the dc circuit. In this power conversion apparatus, when charging the dc capacitor up to its rated dc voltage from the ac power input, charging of the dc capacitor is started by applying the ac power input under conditions in which the first switched valve device of the first switching unit is turned on and the third switched valve device of the second switching unit is turned off, a charge accumulated in the dc capacitor is discharged by turning on the third switched valve device of the second switching unit when an output of the second voltage detector has exceeded a specific set value which is higher than the rated dc voltage by a specific amount, and the third switched valve device of the second switching unit is turned off when the output of the second voltage detector has dropped down to the rated dc voltage.

With this feature, it is possible to charge the dc capacitor in a smooth and reliable fashion without causing overcharging.

According to a sixth additional feature of the invention, the power conversion apparatus further includes a third switching unit employing a fourth switched valve device connected in series with a dc output terminal of the ac-dc conversion unit, and a current-limiting resistor connected in parallel with the third switching unit. In this power conversion apparatus, when a dc short circuit has occurred due to a failure of any arm of the dc-ac conversion unit, the fourth switched valve device of the third switching unit is turned off so that a following current from the ac power input is suppressed by the current-limiting resistor, and when charging the dc capacitor from the ac power input, the fourth switched valve device of the third switching unit is turned off so that charge current from the ac power input is suppressed by the current-limiting resistor.

According to this feature, the following current flowing in the event of a dc short circuit is suppressed to decrease the short-circuit current, and the dc capacitor is smoothly charged.

According to a seventh additional feature of the invention, the dc circuit has P, C and N terminals, and the dc capacitor and the first switching unit of the P side are provided between the P and C terminals and the dc capacitor and the first switching unit of the N side are provided between the C and N terminals. The dc-ac conversion unit includes a series-connected unit formed of first to fourth arms connected between the P and N terminals, each of the first to fourth arms including a second switched valve device and a diode connected in reverse parallel with each other, a first clamping diode connected between a joint of the first and second arms and the C terminal, and a second clamping diode connected between a joint of the third and fourth arms and the C terminal, wherein the dc-ac conversion unit is a 3-level conversion unit which provides an ac power output from a joint of the second and third arms.

This feature makes it possible to effectively suppress dc short-circuit current in a 3-level power conversion system.

According to an eighth additional feature of the invention, the power conversion apparatus further includes an ac-dc conversion unit connected to an ac power source to convert an ac power input into dc power and supply the latter to the dc circuit. In this power conversion apparatus, the first switching units of the P and N sides are each provided with a diode connected in reverse parallel with the first switched valve device, and the ac-dc conversion unit has three output terminals corresponding to the P, C and N terminals of the dc circuit and provides dc voltages across the P and C terminals and across the C and N terminals of the dc circuit.

This feature makes it possible to effectively suppress dc short-circuit current in a 3-level ac-ac power conversion system having a dc circuit.

According to a ninth additional feature of the invention, the power conversion apparatus further includes first voltage detectors of the P and N sides for detecting voltages across the first switching units of the P and N sides, respectively. In this power conversion apparatus, the first switched valve devices of the first switching units and the second switched valve devices in the first to fourth arms of the dc-ac conversion unit are turned off when an output of the first voltage detectors of either the P or N side has exceeded a specific set value.

This feature makes it possible to interrupt the dc short-circuit current in a simple and reliable fashion.

According to a tenth additional feature of the invention, the power conversion apparatus further includes second voltage detectors of the P and N sides for detecting voltages across the dc capacitors of the P and N sides, respectively, and series-connected units of the P and N sides connected between the P and C terminals and between the C and N terminals of the dc circuit, respectively, each of the series-connected units including a second switching unit employing a third switched valve device and a second discharging resistor. When charging the two dc capacitors up to their rated dc voltage from the ac power input, charging of the two dc capacitors is started by applying the ac power input under conditions in which the first switched valve devices of the two first switching units are turned on and the third switched valve devices of the two second switching units are turned off, a charge accumulated in the dc capacitor is discharged through the second discharging resistor by turning on the third switched valve device of the second switching unit when an output of the second voltage detector has exceeded a specific set value which is higher than the rated dc voltage by a specific amount on each of the P and N sides, and the third switched valve device of the second switching unit is turned off when the output of the second voltage detector has dropped down to the rated dc voltage on each of the P and N sides.

With this feature, it is possible to charge the dc capacitor in a smooth and reliable fashion without causing overcharging.

According to an eleventh additional feature of the invention, the power conversion apparatus further includes a voltage differential detector for outputting an end-of-charge signal when the difference between the outputs of the second voltage detectors of the P and N sides has become zero, and an output interrupter for interrupting an output of the voltage differential detector during a specific set period of time from a point in time when either of the outputs of the second voltage detectors has exceeded a specific set value which is lower than the rated dc voltage.

This feature makes it possible to recognize an ending point of charging the two dc capacitors.

According to a twelfth additional feature of the invention, the power conversion apparatus further includes third switching units of the P and N sides employing fourth switched valve devices connected in series with dc output terminals of the P and N sides of the ac-dc conversion unit, respectively, and current-limiting resistors of the P and N sides individually connected in parallel with the two third switching units of the P and N sides, respectively. In this power conversion apparatus, when a dc short circuit has occurred due to a failure of any one of the arms of the dc-ac conversion unit, the fourth switched valve devices of the two third switching units are turned off so that following current from the ac power input is suppressed by the current-limiting resistors, and when charging the dc capacitors of the P and N from the ac power input, the fourth switched valve devices of the third switching units are turned off so that charge current from the ac power input is suppressed by the two current-limiting resistors.

According to this feature, the following current flowing in the event of a dc short circuit is suppressed to decrease the short-circuit current, and the dc capacitor is smoothly charged.

According to a thirteenth additional feature of the invention, the power conversion apparatus further includes first discharging resistors of the P and N sides connected in parallel with the first switching units of the P and N sides, respectively. In this power conversion apparatus, charges accumulated in the dc capacitors of the P and N sides are discharged through the two first discharging resistors by turning off the first switched valve devices of the two first switching units and turning on the second switched valve devices in the first to fourth arms of the dc-ac conversion unit.

This feature enables simple and reliable discharging of the two dc capacitors.

According to a fourteenth additional feature of the invention, the power conversion apparatus further includes first discharging resistors of the P and N sides connected in parallel with the first switching units of the P and N sides, respectively, and fifth switched valve devices individually connected in reverse parallel with the first and second clamping diodes of the dc-ac conversion unit. In this power conversion apparatus, charges accumulated in the dc capacitors of the P and N sides are discharged through the two first discharging resistors by turning off the first switched valve devices of the two first switching units and turning on the second switched valve devices in the first and fourth arms and the fifth switched valve devices of the dc-ac conversion unit.

This feature also enables simple and reliable discharging of the two dc capacitors.

According to a fifteenth additional feature of the invention, the ac-dc conversion unit includes a series-connected unit formed of first to fourth arms connected between the P and N terminals of the dc circuit, each of the first to fourth arms including a sixth switched valve device and a diode connected in reverse parallel with each other, a first clamping diode connected between a joint of the first and second arms and the C terminal, and a second clamping diode connected between a joint of the third and fourth arms and the C terminal, wherein the ac-dc conversion unit is a 3-level conversion unit which accepts the ac power input from a joint of the second and third arms.

This feature makes it possible to effectively suppress dc short-circuit current in an ac-ac power conversion system having a dc circuit and a 3-level conversion unit.

According to a sixteenth additional feature of the invention, when a dc short circuit has occurred in one of the P and N sides of the dc-ac conversion unit, overcharge of the dc capacitor of the side in which the dc short circuit has not occurred is prevented by turning off the first switched valve devices of the first switching units of the P and N sides and the sixth switched valve devices of the first and fourth arms of all phases of the ac-dc conversion unit, and turning on the sixth switched valve devices of the second and third arms of all phases of the ac-dc conversion unit.

This feature makes it possible to effectively prevent a phenomenon in which the dc capacitor is overcharged from the ac power source when a dc short circuit has occurred.

According to a seventeenth additional feature of the invention, the power conversion apparatus further includes seventh switched valve devices connected in reverse parallel with the first and second clamping diodes of the ac-dc conversion unit. In this power conversion apparatus, when a dc short circuit has occurred in one of the P and N sides of the dc-ac conversion unit, overcharge of the dc capacitor of the side in which the dc short circuit has not occurred is prevented by turning off the first switched valve devices of the first switching units of the P and N sides and the sixth switched valve devices of the first and fourth arms of all phases of the ac-dc conversion unit, and turning on the sixth switched valve devices of the second and third arms of all phases of the ac-dc conversion unit and the seventh switched valve devices.

This feature also makes it possible to effectively prevent a phenomenon in which the dc capacitor is overcharged from the ac power source when a dc short circuit has occurred.

According to an eighteenth additional feature of the invention, the power conversion apparatus further includes first discharging resistors of the P and N sides connected in parallel with the first switching units of the P and N sides, respectively. In this power conversion apparatus, the dc capacitors of the P and N sides are discharged through the two first discharging resistors by disconnecting the ac-dc conversion unit from the ac power source after the apparatus has stopped, turning off the first switched valve devices of the two first switching units, and turning on the sixth switched valve devices of the first to fourth arms of the ac-dc conversion unit.

This feature makes it possible to smoothly charge the two dc capacitors.

According to a nineteenth additional feature of the invention, the power conversion apparatus further includes fourth switching units of the P and N sides connected in series with the first switching units of the P and N sides, respectively, each of the fourth switching units including an eighth switched valve device connected in reverse polarity with the first switched valve device of the first switching unit and a diode connected in reverse parallel with the eighth switched valve device, and third discharging resistors of the P and N sides connected in parallel with the fourth switching units of the P and N sides, respectively. In this power conversion apparatus, when charging the dc capacitors of the P and N sides from the ac power input, the two dc capacitors are charged through the diodes of the first to fourth arms of the ac-dc conversion unit, the diodes of the two first switching units and the two third discharging resistors by turning off the sixth switched valve devices of the first to fourth arms of the ac-dc conversion unit and the eighth switched valve devices of the two fourth switching units, and when the charging has finished, the eighth switched valve devices of the two fourth switching units are turned on.

This feature also makes it possible to smoothly charge the two dc capacitors.

What is claimed is:

1. A power conversion apparatus comprising:
a dc circuit formed of a series-connected unit including a dc capacitor and a first switching unit employing a first switched valve device; and
a dc-ac conversion unit which is formed of a plurality of arms individually employing second switched valve devices and, connected to said dc circuit, converts dc power into ac power;
wherein the first switched valve device suppresses short-circuit current which flows through any healthy one of the arms when a dc short circuit has occurred due to a failure of any one of the arms; and
wherein voltage-driven switched valve devices are used as the first and second switched valve devices and, on the grounds that the duty cycle of the first switched valve device is lower than that of the second switched valve devices during operation, on-gate voltage of the first switched valve device is made lower than that of the second switched valve devices, thereby enhancing an effect of suppressing the short-circuit current of the first switched valve device.

2. A power conversion apparatus comprising:
a dc circuit formed of a series-connected unit including a dc capacitor and a first switching unit employing a first switched valve device; and
a dc-ac conversion unit which is formed of a plurality of arms individually employing second switched valve devices and, connected to said dc circuit, converts dc power into ac power;
wherein the first switched valve device suppresses short-circuit current which flows through any healthy one of the arms when a dc short circuit has occurred due to a failure of any one of the arms; and
wherein voltage-driven switched valve devices having approximately the same current capacity are used as the first and second switched valve devices and, on the grounds that the duty cycle of the first switched valve device is lower than that of the second switched valve devices during operation, the number of constituent devices arranged in parallel to constitute the first switched valve device is made smaller than the number of constituent devices arranged in parallel to constitute each of the second switched valve devices, thereby enhancing an effect of suppressing the short-circuit current of the first switched valve device.

3. The power conversion apparatus according to claim 1 further comprising:
an ac-dc conversion unit connected to an ac power source to convert an ac power input into dc power and supply the latter to the dc circuit;
wherein the first switching unit includes a diode connected in reverse parallel with the first switched valve device.

4. The power conversion apparatus according to claim 1 further comprising:
a first voltage detector for detecting a voltage across the first switching unit;
wherein the first switched valve device of the first switching unit and the second switched valve devices of the dc-ac conversion unit are turned off when an output of the first voltage detector has exceeded a specific set value.

5. The power conversion apparatus according to claim 1 further comprising:
a first discharging resistor connected in parallel with the first switching unit;
wherein a charge accumulated in the dc capacitor is discharged through the first discharging resistor by turning off the first switched valve device of the first switching unit and turning on the second switched valve devices of the dc-ac conversion unit.

6. The power conversion apparatus according to claim 1 further comprising:
a first discharging resistor connected in parallel with the first switching unit; and
a series-connected unit including a second switching unit employing a third switched valve device and a second discharging resistor connected between terminals of the dc circuit;
wherein a charge accumulated in the dc capacitor is discharged through the first and second discharging resistors by turning off the first switched valve device of the first switching unit and turning on the third switched valve device of the second switching unit.

7. The power conversion apparatus according to claim 3 further comprising:
a second voltage detector for detecting a voltage across the dc capacitor; and
a series-connected unit including a second switching unit employing a third switched valve device and a second discharging resistor connected between terminals of the dc circuit;
wherein, when charging the dc capacitor up to its rated dc voltage from the ac power input; charging of the dc capacitor is started by applying the ac power input under conditions in which the first switched valve device of the first switching unit is turned on and the third switched valve device of the second switching unit is turned off, a charge accumulated in the dc capacitor is discharged by turning on the third switched valve device of the second switching unit when an output of the second voltage detector has exceeded a specific set value which is higher than said rated dc voltage by a specific amount, and the third switched valve device of the second switching unit is turned off when the output of the second voltage detector has dropped down to said rated dc voltage.

8. The power conversion apparatus according to claim 3 further comprising:
a third switching unit employing a fourth switched valve device connected in series with a dc output terminal of the ac-dc conversion unit; and
a current-limiting resistor connected in parallel with the third switching unit;
wherein, when a dc short circuit has occurred due to a failure of any one of the arms of the dc-ac conversion unit, the fourth switched valve device of the third switching unit is turned off so that a following current from the ac power input is suppressed by the current-limiting resistor, and when charging the dc capacitor from the ac power input, the fourth switched valve device of the third switching unit is turned off so that charge current from the ac power input is suppressed by the current-limiting resistor.

9. The power conversion apparatus according to claim 1, wherein the dc circuit has P, C and N terminals;
wherein the dc capacitor and the first switching unit of the P side are provided between the P and C terminals and the dc capacitor and the first switching unit of the N side are provided between the C and N terminals;
wherein the dc-ac conversion unit includes a series-connected unit formed of first to fourth arms connected between the P and N terminals, each of the first to fourth arms including the second switched valve device and a diode connected in reverse parallel with each other, a first clamping diode connected between a joint of the first and second arms and the C terminal, and a second clamping diode connected between a joint of the third and fourth arms and the C terminal, and wherein the dc-ac conversion unit is a 3-level conversion unit which provides an ac power output from a joint of the second and third arms.

10. The power conversion apparatus according to claim 9 further comprising:
an ac-dc conversion unit connected to an ac power source to convert an ac power input into dc power and supply the latter to the dc circuit;
wherein the first switching units of the P and N sides are each provided with a diode connected in reverse parallel with the first switched valve device, and the ac-dc conversion unit has three output terminals corresponding to the P, C and N terminals of the dc circuit and provides dc voltages across the P and C terminals and across the C and N terminals.

11. The power conversion apparatus according to claim 9 further comprising:
first voltage detectors of the P and N sides for detecting voltages across the first switching units of the P and N sides, respectively;
wherein the first switched valve devices of the two first switching units and the second switched valve devices in the first to fourth arms of the dc-ac conversion unit are turned off when an output of the first voltage detectors of either the P or N side has exceeded a specific set value.

12. The power conversion apparatus according to claim 10 further comprising:
second voltage detectors of the P and N sides for detecting voltages across the dc capacitors of the P and N sides, respectively; and
series-connected units of the P and N sides connected between the P and C terminals and between the C and N terminals of the dc circuit, respectively, each of the series-connected units including a second switching unit employing a third switched valve device and a second discharging resistor;
wherein, when charging the two dc capacitors up to their rated dc voltage from the ac power input, charging of the two dc capacitors is started by applying the ac power input under conditions in which the first switched valve devices of the two first switching units are turned on and the third switched valve devices of the two second switching units are turned off, a charge accumulated in the dc capacitor is discharged through the second discharging resistor by turning on the third switched valve device of the second switching unit when an output of the second voltage detector has exceeded a specific set value which is higher than said rated dc voltage by a specific amount on each of the P and N sides, and the third switched valve device of the second switching unit is turned off when the output of the second voltage detector has dropped down to said rated dc voltage on each of the P and N sides.

13. The power conversion apparatus according to claim 12 further comprising:
a voltage differential detector for outputting an end-of-charge signal when the difference between the outputs of the second voltage detectors of the P and N sides has become zero; and
an output interrupter for interrupting an output of the voltage differential detector during a specific set period of time from a point in time when either of the outputs of the second voltage detectors has exceeded a specific set value which is lower than said rated dc voltage.

14. The power conversion apparatus according to claim 10 further comprising:
third switching units of the P and N sides employing fourth switched valve devices connected in series with dc output terminals of the P and N sides of the ac-dc conversion unit, respectively; and
current-limiting resistors of the P and N sides individually connected in parallel with the two third switching units of the P and N sides, respectively;
wherein, when a dc short circuit has occurred due to a failure of any one of the arms of the dc-ac conversion unit, the fourth switched valve devices of the two third switching units are turned off so that following current from the ac power input is suppressed by the current-limiting resistors, and when charging the dc capacitors of the P and N from the ac power input, the fourth switched valve devices of the third switching units are turned off so that charge current from the ac power input is suppressed by the two current-limiting resistors.

15. The power conversion apparatus according to claim 9 further comprising:
first discharging resistors of the P and N sides connected in parallel with the first switching units of the P and N sides, respectively;
wherein charges accumulated in the dc capacitors of the P and N sides are discharged through the two first discharging resistors by turning off the first switched valve devices of the two first switching units and turning on the second switched valve devices in the first to fourth arms of the dc-ac conversion unit.

16. The power conversion apparatus according to claim 9 further comprising:
first discharging resistors of the P and N sides connected in parallel with the first switching units of the P and N sides, respectively; and
fifth switched valve devices individually connected in reverse parallel with the first and second clamping diodes of the dc-ac conversion unit;
wherein charges accumulated in the dc capacitors of the P and N sides are discharged through the two first discharging resistors by turning off the first switched valve devices of the two first switching units and turning on the second switched valve devices in the first and fourth arms and the fifth switched valve devices of the dc-ac conversion unit.

17. The power conversion apparatus according to claim 10 wherein said ac-dc conversion unit includes:
a series-connected unit formed of first to fourth arms connected between the P and N terminals of the dc circuit, each of the first to fourth arms including a sixth switched valve device and a diode connected in reverse parallel with each other, a first clamping diode connected between a joint of the first and second arms and the C terminal, and a second clamping diode connected between a joint of the third and fourth arms and the C terminal, and wherein the ac-dc conversion unit is a 3-level conversion unit which accepts the ac power input from a joint of the second and third arms.

18. The power conversion apparatus according to claim 17 wherein, when a dc short circuit has occurred in one of the P and N sides of the dc-ac conversion unit, overcharge of the dc capacitor of the side in which the dc short circuit has not occurred is prevented by turning off the first switched valve devices of the first switching units of the P and N sides and the sixth switched valve devices of the first and fourth arms of all phases of the ac-dc conversion unit, and turning on the sixth switched valve devices of the second and third arms of all phases of the ac-dc conversion unit.

19. The power conversion apparatus according to claim 17 further comprising:
seventh switched valve devices connected in reverse parallel with the first and second clamping diodes of the ac-dc conversion unit;
wherein, when a dc short circuit has occurred in one of the P and N sides of the dc-ac conversion unit, overcharge of the dc capacitor of the side in which the dc short circuit has not occurred is prevented by turning off the first switched valve devices of the first switching units of the P and N sides and the sixth switched valve devices of the first and fourth arms of all phases of the ac-dc conversion unit, and turning on the sixth switched valve devices of the second and third arms of all phases of the ac-dc conversion unit and the seventh switched valve devices.

20. The power conversion apparatus according to claim 17 further comprising:
first discharging resistors of the P and N sides connected in parallel with the first switching units of the P and N sides, respectively;
wherein the dc capacitors of the P and N sides are discharged through the two first discharging resistors by disconnecting the ac-dc conversion unit from the ac power source after the apparatus has stopped, turning off the first switched valve devices of the two first switching units, and turning on the sixth switched valve devices of the first to fourth arms of the ac-dc conversion unit.
